(19) United States
(12) Patent Application Publication
(10) Pub. No.: US 2015/0149752 A1
(43) Pub. Date: May 28, 2015

(54) SERVER AND CONTROL METHOD THEREOF

(71) Applicants: Inventec Corporation, Taipei City (TW); Inventec (Pudong) Technology Corporation, Shanghai (CN)

(72) Inventors: Wei Huang, Shanghai City (CN); Yu-Xi Chen, Shanghai City (CN)

(73) Assignees: Inventec Corporation, Taipei City (TW); Inventec (Pudong) Technology Corporation, Shanghai (CN)

(21) Appl. No.: 14/158,983

(22) Filed: Jan. 20, 2014

(30) Foreign Application Priority Data
Nov. 22, 2013 (CN) 201310597233.X

(51) Int. Cl. G06F 9/44

(52) U.S. Cl. CPC G06F 9/4406
USPC 713/2

(57) ABSTRACT

The disclosure provides a server and a control method thereof, and the server includes a memory unit and a basic input/output system (BIOS). The memory has an address space into which a specific string is written. When the server is booted, the BIOS is started to inquire the address space and determine whether the address space has the specific string or not, to determine whether to load a BIOS default setup. When the address space has the specific string, the BIOS loads the BIOS default setup and deletes the specific string in the address space.

### CROSS-REFERENCE TO RELATED APPLICATIONS

This non-provisional application claims priority under 35 U.S.C. §119(e) on Patent Application No(s). 201310597233.X filed in China on Nov. 22, 2013, the entire contents of which are hereby incorporated by reference.

### TECHNICAL FIELD

This disclosure relates to a server and a control method thereof, more particularly to a server and a control method thereof that can automatically load the basic input/output system (BIOS) default setting.

### BACKGROUND

Generally, before servers are produced completely, the inspectors need to first execute the process of loading the BIOS default setup into the server. This process may be carried out by triggering the BIOS to load the BIOS default setup through jumpers, or by entering into a BIOS setup interface to load the BIOS default setup when the server is booting.

However, if servers have been assembled at the production line and each server triggers its BIOS to load the BIOS default setup through jumpers, the inspectors need to dismantle the case of the server before the BIOS default setup is loaded, and then reassemble the server after the BIOS setup is loaded. On the other hand, if these servers load the BIOS default setup through the BIOS interface during the booting of the server, the inspectors need to first boot the server once before the BIOS default setup is loaded, then reboot the server after the BIOS default setup is loaded.

Thus, since the inspectors have to spend a period of time (generally 10 min per server) on loading the BIOS default setup into every server, the time of production is greatly affected and lengthened.

### SUMMARY

According to one or more embodiments of the disclosure, a server control method comprises steps of: booting the server; starting a BIOS in the server, and inquiring an address space in a storage unit by the BIOS; by the BIOS, determining whether there is a specific string in the address space, to determine whether to load a BIOS default setup; loading the BIOS default setup and deleting the specific string from the address space by the BIOS when the BIOS determines that there is the specific string in the address space; and starting an operating system of the server.

According to one of the embodiments, booting the server comprises booting the server for the first time after a user obtains the server.

According to one of the embodiments, the storage unit is a complementary metal-oxide-semiconductor (CMOS) storage unit, and the address space is an unoccupied space in the CMOS storage unit.

According to one of the embodiments, the storage unit is used for storing hardware parameter setup information of the server set up by the BIOS, and the server further comprises a backup battery for powering the storage unit when the server is powered off.

According to one of the embodiments, the server further comprises a BIOS read-only storage unit for storing the BIOS default setup.

According to one or more embodiments of the disclosure, a server comprises a storage unit, having address space in which there is a specific string; and a BIOS, for being started to inquire the address space, determine whether there is the specific string in the address space, and determine whether to load a BIOS default setup or not, when the server is booted. When the BIOS determines there is the specific string in the address space, the BIOS loads the BIOS default setup and deletes the specific string from the address space.

According to one of the embodiments, that the server is booted comprises that the server is booted for the first time after a user obtains the server.

According to one of the embodiments, the storage unit is a CMOS storage unit, and the address space is an unoccupied space in the CMOS storage unit.

According to one of the embodiments, the storage unit is used for storing hardware parameter setup information of the server set up by the BIOS, and the server further comprises a backup battery for powering the storage unit when the server is powered off.

According to one of the embodiments, the server further comprises a BIOS read-only storage unit for storing the BIOS default setup.

### BRIEF DESCRIPTION OF THE DRAWINGS

The present disclosure will become more fully understood from the detailed description given herein below, along with the accompanying drawings which are for illustration only, thus are not limitative of the present disclosure, and wherein:

FIG. 1 is a function diagram of a server in an embodiment in the disclosure; and

FIG. 2 is a flow chart of a server control method in an embodiment in the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### An Embodiment of a Server

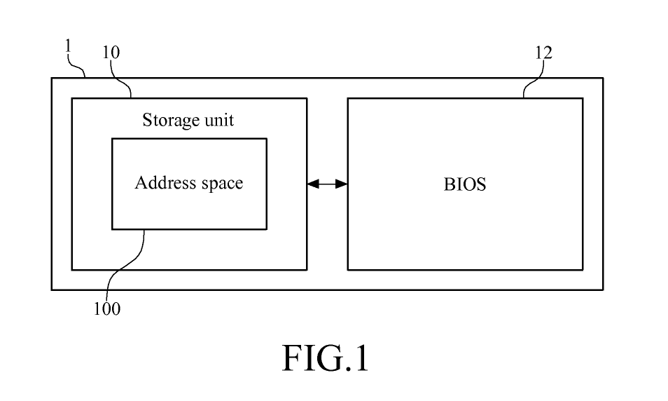

FIG. 1 is a function diagram of a server in an embodiment in the disclosure. As shown in FIG. 1, the server 1 comprises a storage unit 10 and a BIOS 12. The detailed description of the components of the server 1 is below.

The storage unit 10 has address space 100 into which a specific string can be written. The storage unit 10 is, for example, a complementary metal oxide semiconductor (CMOS) storage unit, and the address space 100 is, for example, unoccupied space in the CMOS storage unit. In one exemplary embodiment, the specific string is written into the address space 100 by a script file executed by a writing module or a compiling module (not shown in FIG). The CMOS storage unit is configured for storing the hardware parameter setup information of the server 1 set up by the BIOS 12. In one exemplary embodiment, the server 1 further comprises a backup battery for powering the CMOS storage unit to prevent data in the CMOS storage unit from being lost when the server 1 is powered off.

The disclosure does not have any limitations on the bytes, string content, or location of the specific string in the storage unit 10. For example, the specific string may be designed as “ INVE_” and be stored in the address space 100 which is from 0x50 to 0x54 of the upper 128 bytes of space in the CMOS storage unit. Also, the writing module mentioned above may be a programmer, compiler or an executable program, but the disclosure is not limited thereto. The script file is, for example, a text file which can be established by any possible text editors, and the content of the script file may be, but not limited thereto:

PCMOS/set_reg 0x72 0x50 0x49//“I”

PCMOS/set_reg 0x72 0x51 0x4E//“N”

PCMOS/set_reg 0x72 0x52 0x56//“V”

PCMOS/set_reg 0x72 0x53 0x45//“E”

PCMOS/set_reg 0x72 0x54 0x5F//“_”.

After the server 1 is booted, the BIOS 12 will be started to inquire the address spaces 100 and determine whether the address space 100 has the specific string, to determine whether to load the BIOS default setup. In more detail, when the BIOS 12 determines that the address space 100 has the specific string, the BIOS 12 will load the BIOS default setup and delete the specific string from the address space 100, to prevent the server 1 from reloading the BIOS default setup when next time the server 1 is booted. This means that the server 1 will reload the BIOS default setup when next time the server 1 is booted if the specific string still exists in the address space 100. Alternately, when the BIOS 12 determines that the address space 100 does not have the specific string, the BIOS 12 will continue to operate normally and will not load the BIOS default setup. Booting the server 1 means that the server 1 is booted for the first time after the user obtains the server 1 from the manufacturer of the server 1.

The disclosure is not limited by the execution order of loading the BIOS default setup and deleting the specific string. In one exemplary embodiment, the BIOS 12 will first delete the specific string in the address space 100 of the storage unit 10, and then load the BIOS default setup.

Moreover, the BIOS 12 further comprises a BIOS read-only storage unit (not shown in the drawings). The BIOS read-only storage unit stores the BIOS default setup described above.

### An Embodiment of a Server Control Method

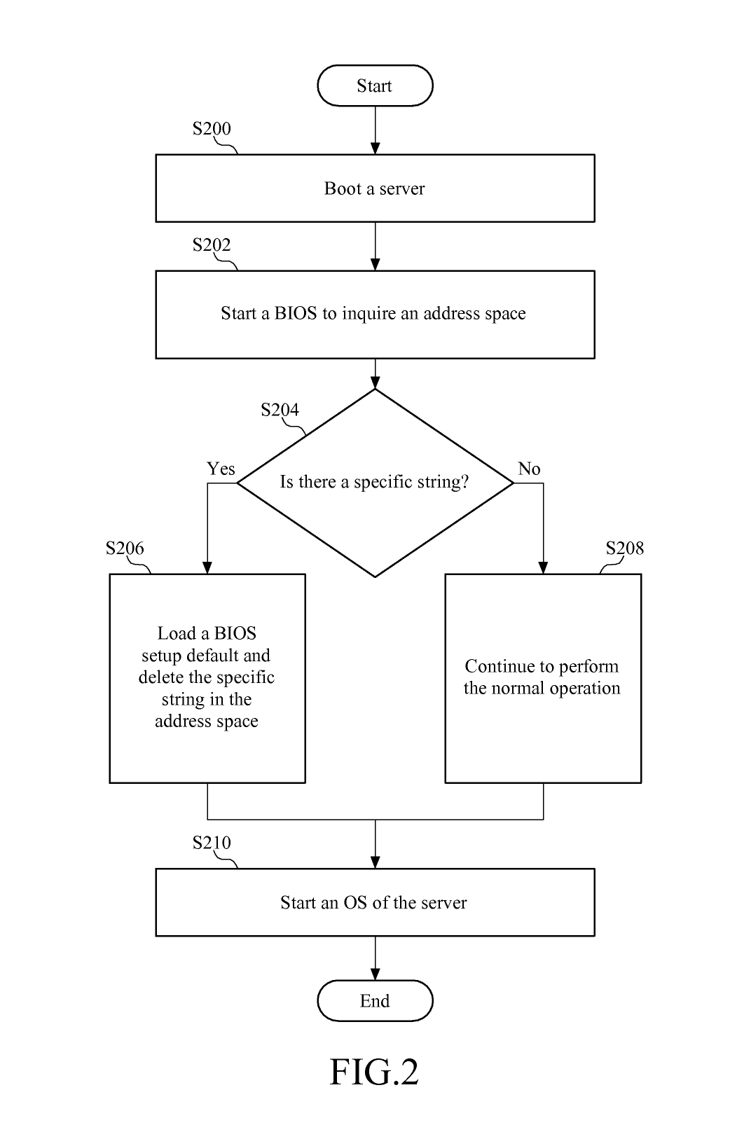

FIG. 2 is a flow chart of a server control method in an embodiment in the disclosure. As shown in FIG. 2, the server control method is applied to the server 1 shown in FIG. 1. The detailed description of the method is illustrated below.

In step S200, the server 1 is booted. Booting the server 1 comprises that the server 1 is booted for the first time after the user obtains the server 1 from the manufacturer of the server 1. In step S202, the BIOS 12 starts to operate in the server 1 and inquires an address space 100 in the storage unit 10. In step S204, the BIOS 12 determines whether there is a specific string in the address space 100. If the BIOS 12 determines that there is a specific string in the address space 100, step S206 is executed; and if the BIOS 12 determines that there is no specific string in the address space 100, step S208 is executed.

In step S206, the BIOS 12 loads the BIOS default setup and deletes the specific string in the address space 100. In step S208, the BIOS 12 continues to perform its normal operation to complete the power on self-test (POST). In step S210, the operating system of the server 1 is started. Moreover, the storage unit 10 is, for example, a CMOS storage unit, the address space 100 is, for example, the unoccupied space in the CMOS storage unit, and the BIOS default setup is stored in a BIOS read-only storage unit. In one exemplary embodiment, steps S204 and S206 are part of the power on self-test (POST) process of the BIOS 12.

Furthermore, before the server 1 is booted (step S200), a script file is also executed to write the specific string into the address space 100 mentioned above. Because the manufacturers writes the specific string into the address space 100 of the storage unit 10 during the producing process of the server 1, when the user boots the server 1 for the first time, the BIOS 12 of the server 1 will determine that the address space 100 has the specific string. Herein, the BIOS 12 will load the BIOS default setup, and delete the specific string in the address space 100 before starting the operating system, to prevent the server 1 from reloading the BIOS default setup when the server is booted next time. The steps of loading the BIOS default setup and deleting the specific string of the address space 100 in the server control method of the present disclosure may be part of the power on self-test (POST) process of the BIOS when booting the server 1.

In summary, the present disclosure provides a server and a control method thereof, where when the server is booting, the BIOS of the server will inquire an address space in the storage unit to determine whether there is a specific string in the address space, to determine whether to load a BIOS default setup. When there is the specific string in the address space, the BIOS will load the BIOS default setup and delete the specific string from the address space. When there is no specific string in the address space, the BIOS will continue to function normally and not load the BIOS default setup.

In the prior art, a BIOS default setup is loaded into the server through a BIOS setup interface, and then the server is rebooted after the BIOS default setup is loaded. Alternately, a shield of the server has to be disassembled so that user can set the jumpers in the shield to load a BIOS default setup, and then the shield should be reassembled after the BIOS default setup is loaded. These two ways to load a BIOS default setup consume significant time and human resources. However, in the disclosure, because a BIOS default setup will be loaded into a server automatically when a user boots the server for the first time, the server provider does not need to load a BIOS default setup into every server during production, thereby reducing the production time of the servers and the loading of the manufacturers and increasing the production efficiency and the production.

What is claimed is:

1. A server control method for a server, comprising:
booting the server;
inquiring an address space in a storage unit by a basic input/output system (BIOS) of the server;
by the BIOS, determining whether there is a specific string in the address space, to determine whether to load a BIOS default setup;
loading the BIOS default setup and deleting the specific string from the address space by the BIOS when the BIOS determines that there is the specific string in the address space; and
starting an operating system of the server.

2. The server control method according to claim 1, wherein said booting the server comprises booting the server for the first time after a user obtains the server.

3. The server control method according to claim 1, wherein the storage unit is a complementary metal-oxide-semiconductor (CMOS) storage unit, and the address space is an unoccupied space in the CMOS storage unit.

4. The server control method according to claim 1, wherein the storage unit is used for storing hardware parameter setup information of the server set up by the BIOS, and the server further comprises a backup battery for powering the storage unit when the server is powered off

5. The server control method according to claim 1, wherein the server further comprises a BIOS read-only storage unit for storing the BIOS default setup.

6. A server, comprising:
a storage unit, having an address space in which there is a specific string; and
a BIOS, for inquiring the address space to determine whether there is the specific string in the address space so as to determine whether to load a BIOS default setup or not, when the server is booted;
wherein when the BIOS determines there is the specific string in the address space, the BIOS loads the BIOS default setup and deletes the specific string from the address space.

7. The server according to claim 6, wherein that the server is booted comprises that the server is booted for the first time after a user obtains the server.

8. The server according to claim 6, wherein the storage unit is a CMOS storage unit, and the address space is an unoccupied space in the CMOS storage unit.

9. The server according to claim 8, wherein the storage unit is used for storing hardware parameter setup information of the server set up by the BIOS, and the server further comprises a backup battery for powering the storage unit when the server is powered off

10. The server according to claim 6, wherein the server further comprises a BIOS read-only storage unit for storing the BIOS default setup.
